(19) United States
(12) Patent Application Publication
(10) Pub. No.: US 2015/0186684 A1
(43) Pub. Date: Jul. 2, 2015

(54) POWER SUPPLY AND ELECTRONIC DEVICE WITH POWER SUPPLY

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventors: XIN-SHU WANG, Wuhan (CN); MIN YANG, Wuhan (CN); JIAN-HUNG HUNG, New Taipei (TW)

(21) Appl. No.: 14/518,871

(22) Filed: Oct. 20, 2014

(30) Foreign Application Priority Data
Dec. 26, 2013 (CN) 201310729795.5

(51) Int. Cl. G06F 21/81

(52) U.S. Cl. CPC G06F 21/81

(57) ABSTRACT

A power supply includes a power supply module supplying power for a motherboard, a receiving module, a controlling module, and a switch module. The receiving module receives an unique authorized code and determines if the unique authorized code matches a preset code, which can send a switch-on signal to the controlling module when the unique authorized code matches the preset code. The controlling module sends a high-logic level to the switch module upon receiving the switch-on signal, to switch on the switch module to connect the power supply module with the motherboard. The receiving module sends a switch-off signal to the controlling module when the unique authorized code does not match the preset code, and the controlling module sends a low-logic level to the switch module, to switch off the switch module to disconnect the power supply module from the motherboard.

### CROSS-REFERENCE TO RELATED APPLICATIONS

This application claims priority to Chinese Patent Application No. 201310729795.5 filed on Dec. 26, 2013, the contents of which are incorporated by reference herein.

### FIELD

The subject matter herein generally relates to power supplies.

### BACKGROUND

Electronic devices, such as computers, include a power supply for providing power for electronic devices.

### BRIEF DESCRIPTION OF THE DRAWINGS

Implementations of the present technology will now be described, by way of example only, with reference to the attached figures.

FIG. 1 is a block diagram of one embodiment of a power supply and an authorized card.

FIG. 2 is a block diagram of one embodiment of an electronic device.

FIG. 3 is a block diagram of the power supply and a motherboard of the electronic device of FIG. 1.

FIG. 4 is another block diagram of the electronic device of FIG. 2

FIG. 5 is a flowchart showing one embodiment of a power supply method.

FIG. 6 is a flowchart showing a block 206 of FIG. 5.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

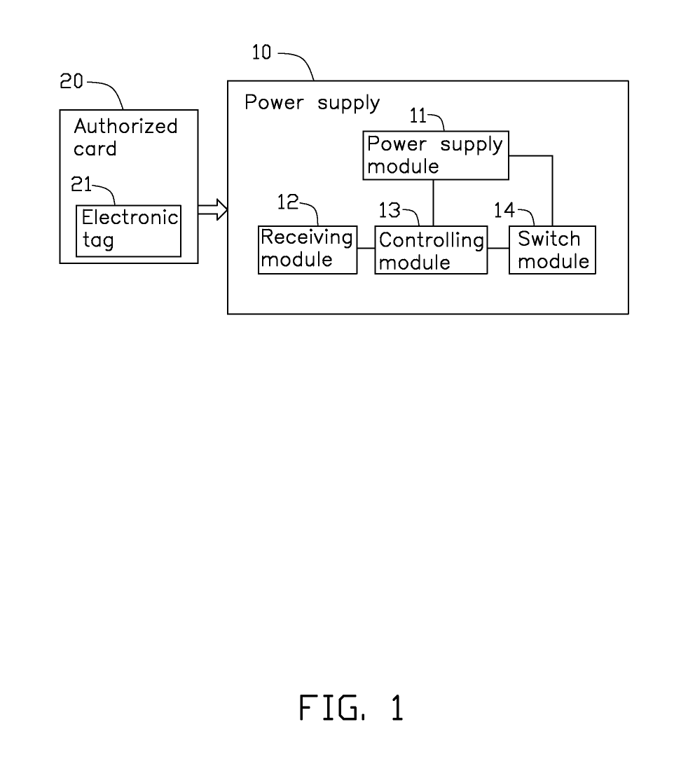

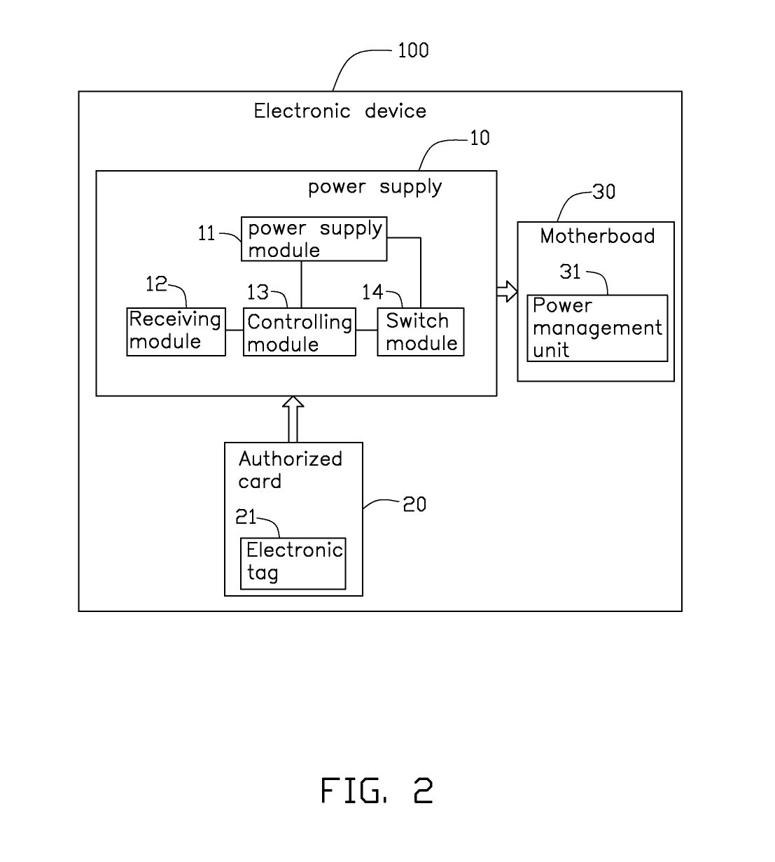

FIGS. 1 and 2 illustrate an electronic device 100 in accordance with one embodiment. The electronic device 100 can include a power supply 10, an authorized card 20, and a motherboard 30. The power supply 10 can supply power for the motherboard 30. In at least one embodiment, the electronic device 100 can be a computer.

The motherboard 30 can include a power management unit 31. The power management unit 31 can output a power-on signal or a power-off signal to the power supply 10.

The authorized card 20 can include an electronic tag 21. The electronic tag 21 can store an unique authorized code for the power supply 10 and can send the unique authorized code.

The power supply 10 can include a power supply module 11, a receiving module 12, a controlling module 13, and a switch module 14. The power supply module 11 can be coupled to the power management unit 31 and can output a power signal upon receiving the power-on signal and can stop outputting the power signal upon receiving the power-off signal. The power supply module 11 can be coupled to the controlling module 13 and can transmit the power-on signal and the power-off signal to the controlling module 13.

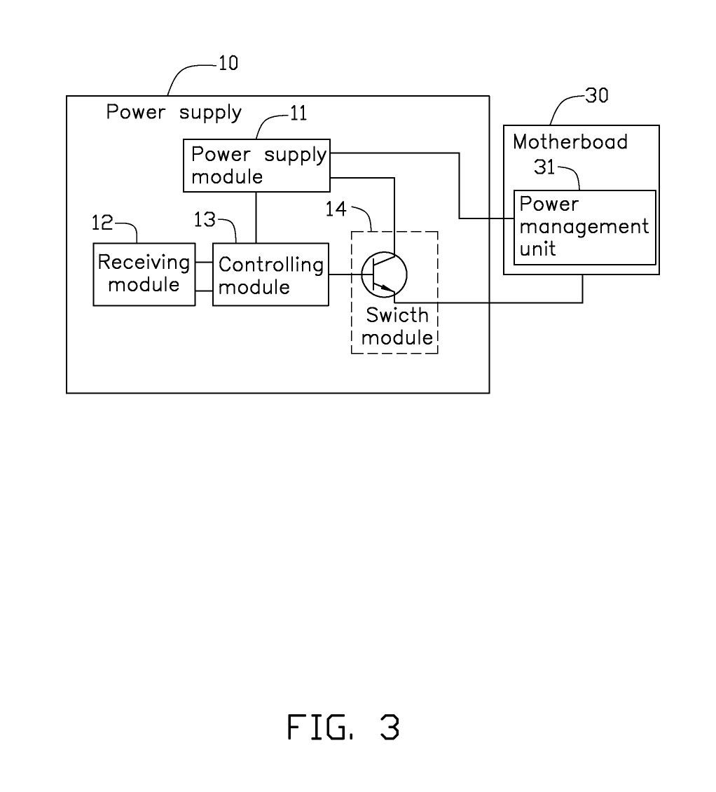

The receiving module 12 can be coupled to the controlling module 13 and can receive the unique authorized code from the authorized card 20. The receiving module 12 can further determine if the unique authorized code match a preset code. When the unique authorized code matches the preset code, the receiving module 12 can send a switch-on signal to the controlling module 13, and the controlling module 13 can send a high-logic level (e.g., 5V) to switch on the switch module 14. Thus, the power supply module 11 can be coupled to the motherboard 30 via the switch module 14 and can supply power for the motherboard 30 when receiving the power-on signal. When the authorized code does not match the preset code, the receiving module 12 can send a switch-off signal to the controlling module 13, and the controlling module 13 can send a low-logic level to switch off the switch module 14. Thus, the power supply module 11 can be disconnected from the motherboard 30 and cannot supply power for the motherboard 30. FIG. 3 shows that in at least one embodiment, the switch module 14 is a transistor. A base terminal of the transistor is coupled to the controlling module 13, and a collector terminal of the transistor is coupled to the power supply module 11. An emitter terminal of the transistor is coupled to the motherboard 30.

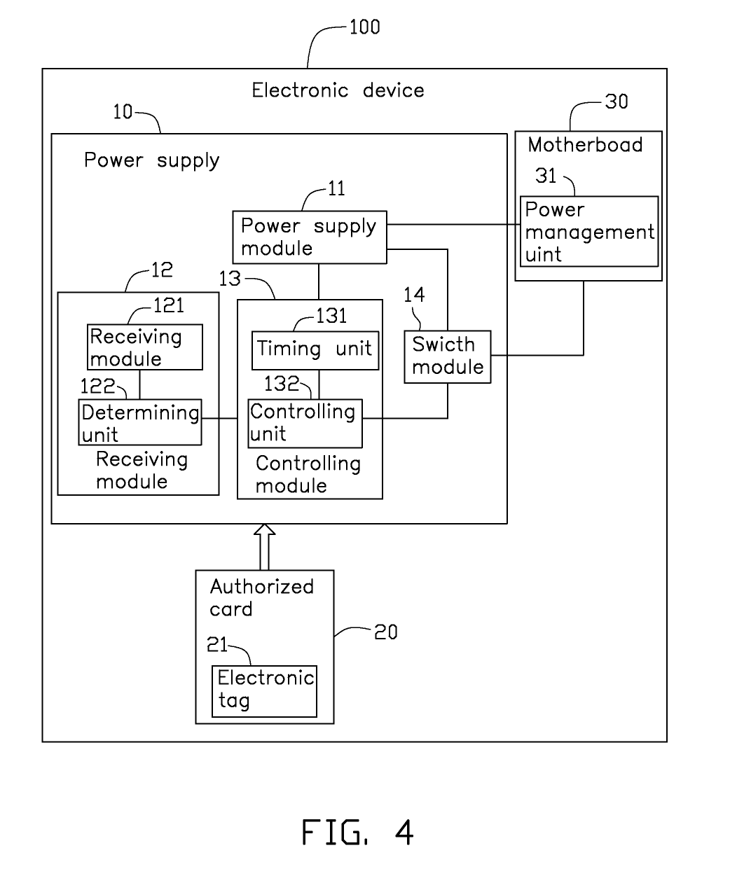

FIG. 4 illustrates that the receiving module 12 can include a receiving unit 121 and a determining unit 122. The receiving unit 121 can receive the unique authorized code. The determining unit 122 can determine if the unique authorized code match the preset code. The determining unit 122 can send the switch-on signal to the controlling module 13 when the unique authorized code matches the preset code. The determining unit 122 can send the switch-off signal to the controlling module 13 when the unique authorized code does not match the preset code.

The controlling module 13 can include a timing unit 131 and a controlling unit 132. The controlling unit 132 can send the high-logic level to switch on the switch module 14 when receiving the switch-on signal and can send the low-logic level to switch off the switch module 14 when receiving the switch-off signal. The controlling unit 132 can notice the timing unit 131 to start timing when receiving the switch-on signal. After the switch module 14 being switched on, the controlling unit 132 can send the low-logic level to switch off the switch module if the controlling unit 132 does not receive the power-on signal in a first preset period.

After the power supply module 11 stops supplying power for the motherboard 30 and the controlling unit 132 receives the power-off signal, the controlling unit 132 can notice the timing unit 131 to start timing time and can send the low-logic level to switch off the switch module if the controlling unit 132 does not receive the power-on signal in a second preset timing time. In contrast, the controlling unit 132 does not send the low-logic level to switch off the switch module when the controlling unit 132 receives the power-on signal in the second preset timing time after receiving the power-off signal. In at least one embodiment, the first preset timing time is 10 minutes, and the second preset timing time is 5 minutes.

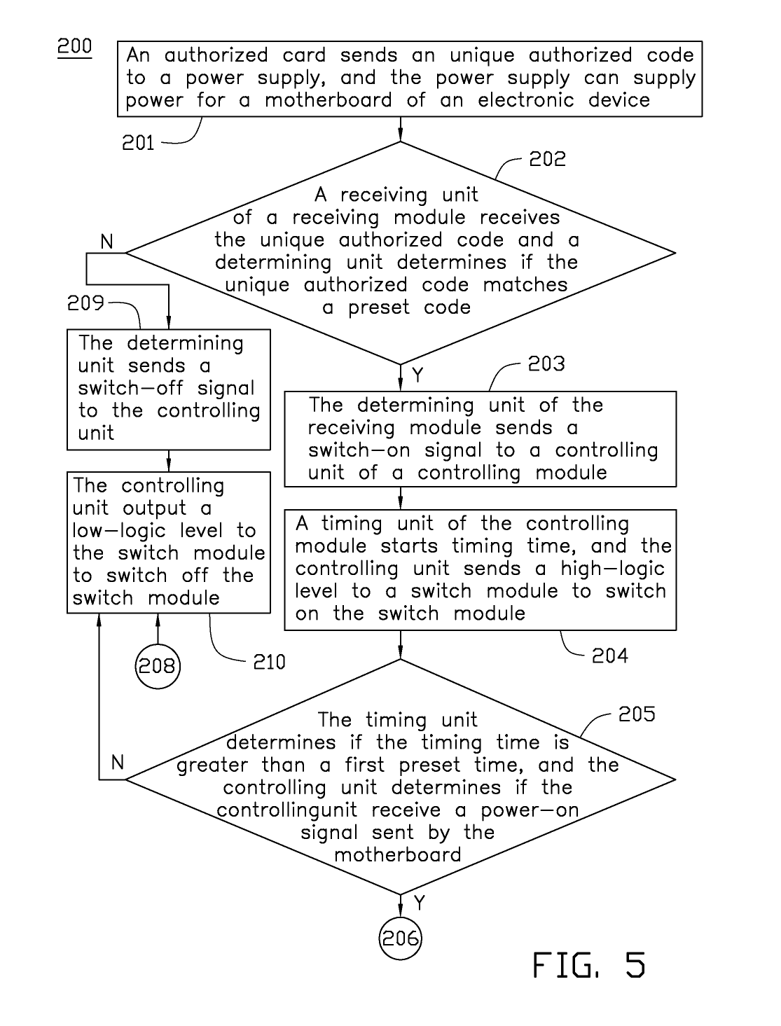

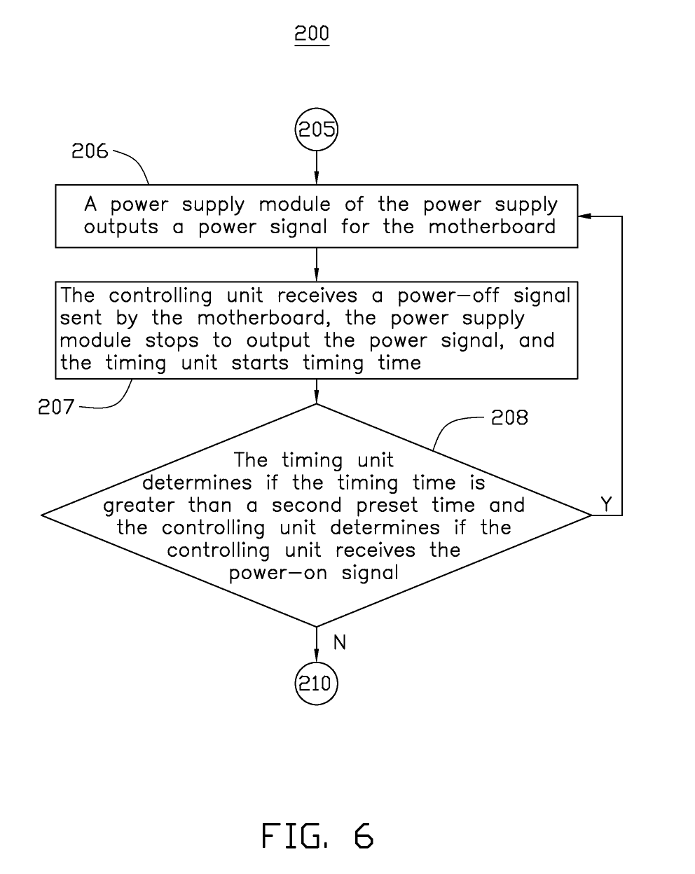

Referring to FIGS. 5 and 6, a flowchart is presented in accordance with an example embodiment which is being thus illustrated. The example method 200 is provided by way of example, as there are a variety of ways to carry out the method. The method 200 described below can be carried out using the configurations illustrated in FIGS. 1-4, for example, and various elements of these figures are referenced in explaining example method 100. Each block shown in FIGS. 5 and 6 represents one or more processes, methods or subroutines, carried out in the exemplary method 200. Additionally, the illustrated order of blocks is by example only and the order of the blocks can change according to the present disclosure. The exemplary method 200 can begin at block 201.

At block 201, an authorized card sends an unique authorized code to a power supply, and the power supply can supply power for a motherboard of an electronic device. In at least one embodiment, the electronic device can be a computer.

At block 202, a receiving unit of a receiving module receives the unique authorized code and a determining unit determines if the unique authorized code match a preset code.

When the unique authorized code matches the preset code, the method goes to block 203. When the unique authorized code does not match the preset code, the method goes to block 209.

At block 203, the determining unit of the receiving module sends a switch-on signal to a controlling unit of a controlling module. In at least one embodiment, the controlling module is an embedded controller.

At block 204, a timing unit of the controlling module starts timing time, and the controlling unit sends a high-logic level to a switch module to switch on the switch module, therefore a power supply module of the power supply is coupled to the motherboard upon receiving a power-on signal sent by the motherboard.

At block 205, the timing unit determines if the timing time is greater than a first preset time and the controlling unit determines if the controlling unit receives the power-on signal. When the timing time is greater than the first preset time, the method goes block 210. When the timing time is not greater than the first preset time and the controlling unit receives the power-on signal, the method goes to block 206.

At block 206, a power supply module of the power supply outputs a power signal for the motherboard.

At block 207, the controlling unit receives a power-off signal sent by the motherboard, the power supply module stops to output the power signal, and the timing unit starts timing time.

At block 208, the timing unit determines if the timing time is greater than a second preset time and the controlling unit determines if the controlling unit receives the power-on signal. When the timing time is greater than the second preset time, the method goes to block 210. When the timing time is not greater than the second preset time and the controlling unit receives the power-on signal, the method goes to block 206.

At block 209, the determining unit sends a switch-off signal to the controlling unit.

At block 210, the controlling unit output a low-logic level to the switch module to switch off the switch module.

The embodiments shown and described above are only examples. Many details are often found in the art such as the other features of a power supply. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A power supply comprising:
a power supply module configured to supply power for a motherboard;
a receiving module configured to receive an unique authorized code and configured to determine if the unique authorized code matches a preset code;
a controlling module coupled to the receiving module; and
a switch module coupled to the controlling module,
wherein the receiving module is configured to send a switch-on signal to the controlling module when the unique authorized code matches the preset code,
the controlling module is configured to send a high-logic level to the switch module upon receiving the switch-on signal,
the switch module is switched on to connect the power supply module with the motherboard,
the receiving module is configured to send a switch-off signal to the controlling module when the unique authorized code does not match the preset code, and
the controlling module is configured to send a low-logic level to the switch module, and the switch module is switched off to disconnect the power supply module from the motherboard.

2. The power supply of claim 1, wherein the switch module is a transistor.

3. The power supply of claim 2, wherein a base terminal of the transistor is coupled to the controlling module, a collector terminal of the transistor is coupled to the power supply module, and an emitter terminal of the transistor is coupled to the motherboard.

4. The power supply of claim 1, wherein the receiving module comprises a receiving unit and a determining unit, the receiving unit is configured to receive the unique authorized code, and the determining unit is configured to determine if the unique authorized code matches the preset code.

5. The power supply of claim 1, wherein the controlling module is configured to start timing when receiving the switch-on signal, and the controlling module is configured to send the low-logic level to the switch module to switch off the switch module if the controlling module does not receive the power-on signal send by the power supply module in a first preset time.

6. The power supply of claim 5, wherein the controlling module is configured to start timing time upon receiving the switch-off signal, the controlling module is configured to send the low-logic level to the switch module to switch off the switch module if the controlling module does not receive the power-on signal in a second preset time.

7. An electronic device comprising:
a motherboard;
an authorized card configured to send an unique authorized code; and
a power supply comprising:
a power supply module configured to supply power for the motherboard;
a receiving module configured to receive the unique authorized code and configured to determine if the unique authorized code matches a preset code;
a controlling module coupled to the receiving module; and
a switch module coupled to the controlling module;
wherein the receiving module is configured to send a switch-on signal to the controlling module when the unique authorized code matches the preset code, the controlling module is configured to send a high-logic level to the switch module upon receiving the switch-on signal, the switch module is switched on to connect the power supply module with the motherboard, and the power supply module is configured to supply power for the motherboard upon receiving a power-on signal; and
the receiving module is configured to send a switch-off signal to the controlling module when the unique authorized code does not match the preset code, and the controlling module is configured to send a low-logic level to the switch module, and the switch module is switched off to disconnect the power supply module from the motherboard.

8. The electronic device of claim 7, wherein the switch module is a transistor.

9. The electronic device of claim 8, wherein a base terminal of the transistor is coupled to the controlling module, a collector terminal of the transistor is coupled to the power supply module, and an emitter terminal of the transistor is coupled to the motherboard.

10. The electronic device of claim 7, wherein the receiving module comprises a receiving unit and a determining unit, the receiving unit is configured to receive the unique authorized code, and the determining unit is configured to determine if the unique authorized code matches the preset code.

11. The electronic device of claim 7, wherein the controlling module is configured to start timing time upon receiving the switch-on signal, and the controlling module is configured to send the low-logic level to the switch module to switch off the switch module when the controlling module does not receive the power-on signal send by the power supply module in a first preset time.

12. The electronic device of claim 11, wherein the controlling module is configured to start timing time upon receiving the switch-off signal, the controlling module is configured to send the low-logic level to the switch module to switch off the switch module when the controlling module does not receive the power-on signal in a second preset time.

13. The electronic device of claim 11, wherein the authorized card comprises an electronic tag, and the electronic tag is configured to store the unique authorized code.

14. The electronic device of claim 11, wherein the motherboard comprises a power management unit, and the power management unit is configured to send the power-on signal to the power supply module.

15. An electronic device comprising:
a motherboard configured to send a power-on signal or a power-off signal; and
a power supply comprising:
a power supply module configured to supply power for the motherboard;
a receiving module configured to receive an unique authorized code and configured to determine if the unique authorized code matches a preset code;
a controlling module coupled to the receiving module; and
a switch module coupled to the controlling module;
wherein the receiving module is configured to send a switch-on signal to the controlling module when the unique authorized code matches the preset code, the controlling module is configured to send a high-logic level to the switch module upon receiving the switch-on signal, the switch module is switched on to connect the power supply module with the motherboard, and the power supply module is configured to supply power for the motherboard upon receiving the power-on signal; and
the receiving module is configured to send a switch-off signal to the controlling module when the unique authorized code does not match the preset code, and the controlling module is configured to send a low-logic level to the switch module, and the switch module is switched off to disconnect the power supply module from the motherboard.

16. The electronic device of claim 15, further comprises an authorized card, wherein the authorized card is configured to send the unique authorized code to the receiving module.

17. The electronic device of claim 15, wherein the switch module is a transistor, a base terminal of the transistor is coupled to the controlling module, a collector terminal of the transistor is coupled to the power supply module, and an emitter terminal of the transistor is coupled to the motherboard.

18. The electronic device of claim 15, wherein the receiving module comprises a receiving unit and a determining unit, the receiving unit is configured to receive the unique authorized code, and the determining unit is configured to determine if the unique authorized code matches the preset code.

19. The electronic device of claim 15, wherein the controlling module is configured to start timing time upon receiving the switch-on signal, and the controlling module is configured to send the low-logic level to the switch module to switch off the switch module when the controlling module does not receive the power-on signal sent by the power supply module in a first preset time.

20. The electronic device of claim 19, wherein the controlling module is configured to start timing time upon receiving the switch-off signal, the controlling module is configured to send the low-logic level to the switch module to switch off the switch module when the controlling module does not receive the power-on signal in a second preset time.
